(19) United States
(12) Patent Application Publication
(10) Pub. No.: US 2005/0023960 A1
(43) Pub. Date: Feb. 3, 2005

(54) Electroluminescence panel and manufacturing process therefor

(76) Inventors: Gaku Harada, Hirakata City (JP); Hisao Haku, Neyagawa City (JP)

Correspondence Address: MCDERMOTT WILL & EMERY LLP, 600 13th Street, N.W., Washington, DC, 20005-3096, US

(21) Appl. No.: 10/868,347

(22) Filed: Jun. 16, 2004

(30) Foreign Application Priority Data
Jun. 18, 2003 (JP) 2003-173823

(51) Int. Cl. H01J 1/62

(52) U.S. Cl. 313/502; 445/24

(57) ABSTRACT

A process for manufacturing a high quality organic EL panel is provided. On a glass substrate is formed an organic EL element, on which is then deposited a protective film. The surface of the device substrate or the sealing substrate is treated with ozone or plasma, and then an adhesive is applied on the surface by screen printing. After placing the device substrate and the sealing substrate in a chamber in a vacuuming apparatus, the inside of the chamber is vacuumed to a pressure of P1. After leaving the substrates for a given period until foaming of volatiles contained in the adhesive ceases, a pressure in the chamber is increased to P2 for preventing foaming of the volatiles, and then the substrates are laminated. Then, the laminate is pressurized and heated for removing microspaces. Finally, the adhesive is cured using, for example, a UV lamp.

### BACKGROUND OF THE INVENTION

1. Field of the Invention

This invention relates to an electroluminescence panel; in particular, it relates to an electroluminescence panel having a structure where a sealing substrate is laminated on a substrate comprising an electroluminescence element and a manufacturing process therefor.

2. Description of the Related Art

As information devices have been diversified, there has been increased the needs for a flat display device whose power consumption is smaller than a cathode ray tube (CRT) commonly used. As one of such flat display devices, an organic electroluminescence (hereinafter, referred to as “organic EL”) element has attracted attention, which exhibits good characteristics such as a higher efficiency, a thinner body, a light weight and less dependence on an angle of visibility. Thus, attempts have been made for developing a display utilizing such an organic EL element.

Among various organic EL elements, an organic EL element comprising a luminescent layer made of an organic material has been expected to be advantageously applied to a display such as a multicolor or full color display because its luminescent color can be varied by appropriately selecting a fluorescent substance as a luminescent material. Since an organic EL element can also perform plane emission at a low voltage, it can be used as a back light for a display such as a liquid crystal display.

To date, the organic EL element described above has been applied to a small display such as a digital camera and a cell phone. An organic EL element is, however, extremely sensitive to moisture. Specifically, an interface between a metal electrode and an organic layer may be deteriorated or broken due to moisture; a metal electrode may be oxidized, leading to a higher resistance; or an organic material itself may be degenerated due to moisture, resulting in problems such as increase in a drive voltage, formation and growth of dark spots and reduction in a luminance.

To solve these problems, there has been suggested a structure where an organic EL element is covered by a moisture-resistant photocurable resin layer and a less water-permeable substrate adhering to the upper surface of the photocurable resin layer (for example, see Patent Reference 1). In the reference, a substrate adhering to a photocurable resin is a water impermeable glass.

Patent Reference 1
Japanese Laid-Open Patent Publication No. 1993-182759.

Patent Reference 2
Japanese Laid-Open Patent Publication No. 2002-110349.

However, as described in Patent Reference 1, a bubble may be generated between a substrate comprising an organic EL element and a glass during placing the glass on the substrate via a photocurable resin layer. If there remains a bubble with a size comparable to a pixel size, the pixel might become less visible.

For solving the problem, Patent Reference 1 has described a method for attaching a water impermeable glass sequentially from one side. Patent Reference 2 has suggested a method for preventing a bubble from remaining in a sealant. According to the method described in Patent Reference 2, when a cover glass on a thin plate is attached on a pixel-forming surface via a sealant, the cover glass is reinforced by a reinforcing sheet and pressed by a roller for gluing. However, in these methods, a cover glass may be dislocated during the attachment step, or a cover glass may be deformed into a saddle shape.

### SUMMARY OF THE INVENTION

In view of the situation, an objective of the present invention is to provide a technique for manufacturing a high-quality organic EL panel.

An aspect of this invention is directed to a process for manufacturing an electroluminescence panel. It is a process for manufacturing an electroluminescence panel, comprising: applying an adhesive on a surface of at least one of a first substrate comprising an electroluminescence element and a second substrate for sealing the electroluminescence element by printing; and laminating the first substrate and the second substrate. Application of an adhesive by printing allows the adhesive to be evenly applied in a short time. Printing methods which can be employed include surface printing, intaglio printing, planographic printing, mimeograph printing (screen printing). Screen printing is a printing procedure where a woven screen of silk, Nylon, Tetron or stainless is directly or indirectly perforated and an adhesive is applied only the holes. Screen printing is particularly suitable because substrates made of various materials can be printed, flexibility of the screen allows printing of a curved surface and an adhesive layer printed is relatively thicker.

The lamination described above may be conducted under a reduced pressure, which can eliminate remaining of a bubble between the first and the second substrates during laminating these substrates. The first substrate may comprise a protective film formed on the electroluminescence element. The protective film may be comprised of only an inorganic layer made of an inorganic material, or of a composite layer comprising the inorganic layer and an organic layer made of an organic material. A protective film comprising an inorganic material exhibiting good moisture resistance and water impermeability may be formed to minimize adverse effect of moisture to an EL element. Furthermore, the protective film formed can prevent adverse effect to element properties due to direct contact of the adhesive with the EL element.

A viscosity of the adhesive may be no less than 0.5 Paxs. In an EL panel, it is preferable to select an adhesive exhibiting good moisture resistance and water impermeability. Such an adhesive generally has a higher viscosity, preferably no less than 0.5 Paxs. When curing the adhesive, a stress is applied to the first or the second substrate due to shrinkage of the adhesive. Since an adhesive with a higher viscosity generally has a smaller shrinking rate during curing, a stress to the substrate is small. It is, therefore, preferable to use an adhesive with a higher viscosity of no less than 0.5 Paxs. The upper limit of a viscosity of an adhesive is preferably 10,000 Paxs in the light of facility in the application step.

Before the application step, the process can comprise the step of treating the surface of the first or the second substrate by ozone or plasma. Treatment by ozone or plasma can improve wettability of the substrate surface and lower a contact angle of the adhesive, so that the adhesive can be evenly extended on the substrate surface to give a smooth surface of the adhesive layer, which can prevent microspaces from being generated between the substrates during laminating them.

The lamination step can comprise the steps of placing the first and the second substrates in a vacuum apparatus, vacuuming the vacuum apparatus to a first pressure, increasing the pressure in the vacuum apparatus to a second pressure higher than the first pressure, and laminating the first and the second substrates under the second pressure. Before the step of vacuuming and after the step of increasing a pressure, the process may have the step of leaving the product for a given period for removing volatiles in the adhesive. It is preferable to laminating the substrates under a reduced pressure for preventing a bubble from remaining between the substrates. During the process, the volatiles in the adhesive may be released as bubbles. When the substrates are laminated during generation of bubbles, bubbles may remain between the substrates and irregularity may be formed on the adhesive surface, leading to formation of microspaces. Thus, after leaving the product under a reduced pressure for a given period for adequately removing the volatiles, a pressure is increased to a sufficient degree for inhibiting bubble generation before lamination. Thus, generation of bubbles or microspaces can be minimized.

The process may further comprise, after the lamination step, the step of heating the laminated substrates under an inert gas atmosphere or under a reduced pressure, or pressurizing the laminate under an inner pressure of the vacuuming apparatus higher than an ambient pressure. A gas which can be used for the inert gas atmosphere may be a rare gas such as argon or an unreactive gas such as nitrogen. The laminated substrates can be pressurized to rapidly eliminate microspaces remaining between the substrates which have been generated under a reduced pressure. During the pressurizing step, the laminate can be heated for reducing a viscosity of the adhesive to more effectively eliminate microspaces generated under a reduced pressure.

In the adhesive application step, different adhesives can be used for a first region comprising the electroluminescence element in the electroluminescence panel and a second region around the first region. An adhesive applied on the second region may be more moisture resistant or less water permeable than an adhesive applied on the first region. Thus, an inner EL element can be more effectively protected from moisture. The adhesive applied on the first region may be less shrinkable or more transparent than the adhesive applied on the second region. Thus, generation of a stress due to shrinkage of the adhesive can be prevented, resulting in improvement in display properties.

Another aspect of this invention is directed to an electroluminescence panel. The electroluminescence panel comprises a first substrate comprising an electroluminescence element and a second substrate for sealing the electroluminescence element, wherein there exist microspaces generated under a reduced pressure which remain between the first and the second substrates and whose diameter is equal to or less than the longer side of a pixel in the electroluminescence element, in a density of 10 or less per a plane with 1 inch diagonal.

Another aspect of this invention is also directed to an electroluminescence panel. The electroluminescence panel comprises a first substrate comprising an electroluminescence element and a second substrate for sealing the electroluminescence element, wherein there exist microspaces generated under a reduced pressure which remain between the first and the second substrates and whose diameter is equal to or less than the shorter side of a pixel in the electroluminescence element, in a density of 50 or less per a plane with 1 inch diagonal. The lengths of the longer and the shorter sides for a pixel may be those for a pixel formed in a common EL panel; for example, the longer and the shorter sides may be about 0.2 mm and about 0.06 mm, respectively.

This summary of the invention does not necessarily describe all necessary features so that the invention may also be a sub-combination of these described features.

### BRIEF DESCRIPTION OF THE DRAWINGS

FIG. 1 shows a structure of an organic EL panel according to an embodiment of this invention.

FIG. 2A, 2B, 2C, 2D and 2E show generation of microspaces between substrates.

FIG. 3 is a flow chart illustrating a process for manufacturing an organic EL panel according to an embodiment of this invention.

FIG. 4 schematically shows application of an adhesive after treating a substrate surface by ozone or plasma.

FIG. 5 shows variation of a pressure within a chamber in a vacuuming apparatus over time during lamination of substrates.

FIG. 6 schematically shows pressurizing and heating of a substrate laminate.

FIG. 7 illustrates an example of the use of different adhesives for a display region and a peripheral region.

FIG. 8 shows the number of remaining microspaces in organic EL panels manufactured as described in Examples and Comparative Example.

### DETAILED DESCRIPTION OF THE INVENTION

The invention will now be described based on the preferred embodiments. This does not intend to limit the scope of the present invention, but exemplify the invention.

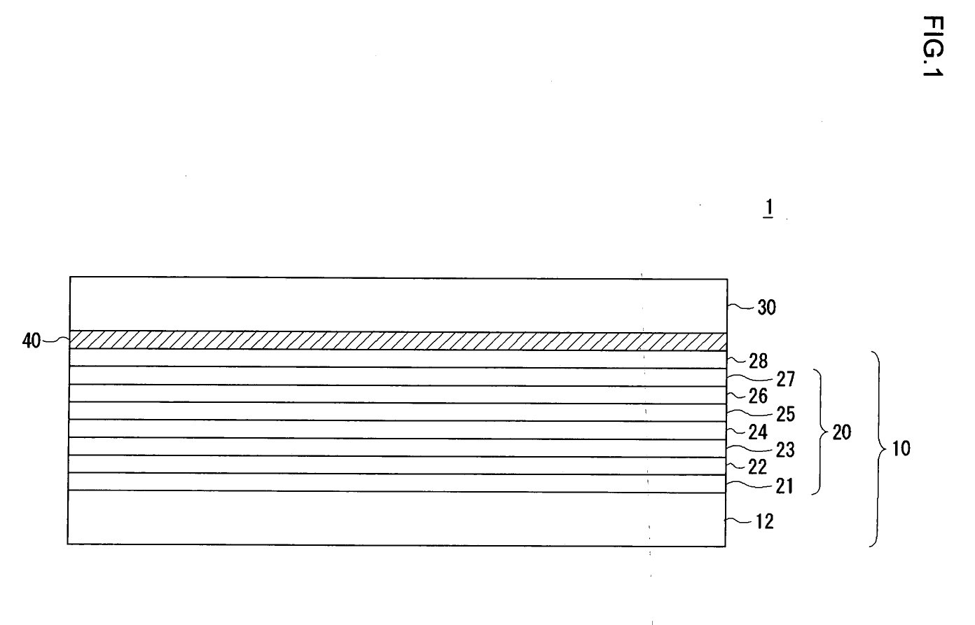

FIG. 1 shows a structure of an organic EL panel 1 according to an embodiment. The organic EL panel 1 has a structure where a second substrate (hereinafter, referred to as a “sealing substrate”) 30 is attached to a first substrate 10 comprising an organic EL element 20 (hereinafter, referred to as a “device substrate”) via an adhesive 40 for protecting the organic EL element 20 as a display element from moisture and external impact. The organic EL element 20 has a structure where on a glass or a substrate 12 comprising a driving circuit such as TFT are deposited an anode 21, a hole injection layer 22, a hole transporting layer 23, a luminescent layer 24, an electron transporting layer 25, an electron injection layer 26 and a cathode 27 in sequence. On the organic EL element 20, a protective film 28 is formed for protecting the organic EL element 20 from moisture. The protective film 28 may be an inorganic layer made of an inorganic material, or a composite layer formed by laminating an organic layer made of an organic material and an inorganic layer.

The adhesive 40 used for laminating the device substrate 10 and the sealing substrate 30 is preferably an adhesive exhibiting excellent moisture resistance and less water permeability for preventing permeation of moisture into the organic EL element 20 through the adhesive 40. However, a less water permeable adhesive such as an epoxy resin generally has a higher viscosity. Thus, when applying the adhesive to a substrate, irregularity may be formed on the surface of the adhesive layer and therefore, microspaces tend to generate between substrates during laminating them. When the lamination step is conducted under a reduced pressure, these microspaces are not bubbles at an ambient pressure, but spaces at a reduced pressure. Therefore, before curing the adhesive, the product can be left for a sufficient period to allow the majority of the spaces to disappear. For laminating a liquid crystal panel or a disk such as a DVD, an adhesive having a lower viscosity of about 0.05 Paxs is generally used and microspaces may disappear in a relatively shorter period. Thus, such spaces are not very problematic. However, when using an adhesive having a higher viscosity in an organic EL panel, it may take a relatively longer time for allowing microspaces to disappear. Thus, it may be not efficient to just leave the product for disappearance of microspaces, leading to a reduced yield. Although the adhesive has a higher viscosity, leaving the adhesive without curing for a long time may cause problems such as dislocation of the substrate and damage to the organic EL element due to permeation of moisture contained in the adhesive. Thus, this embodiment suggests a technique for minimizing microspaces during lamination of the substrates; for allowing the microspaces generated in a short time; and for minimizing the number of remaining microspaces.

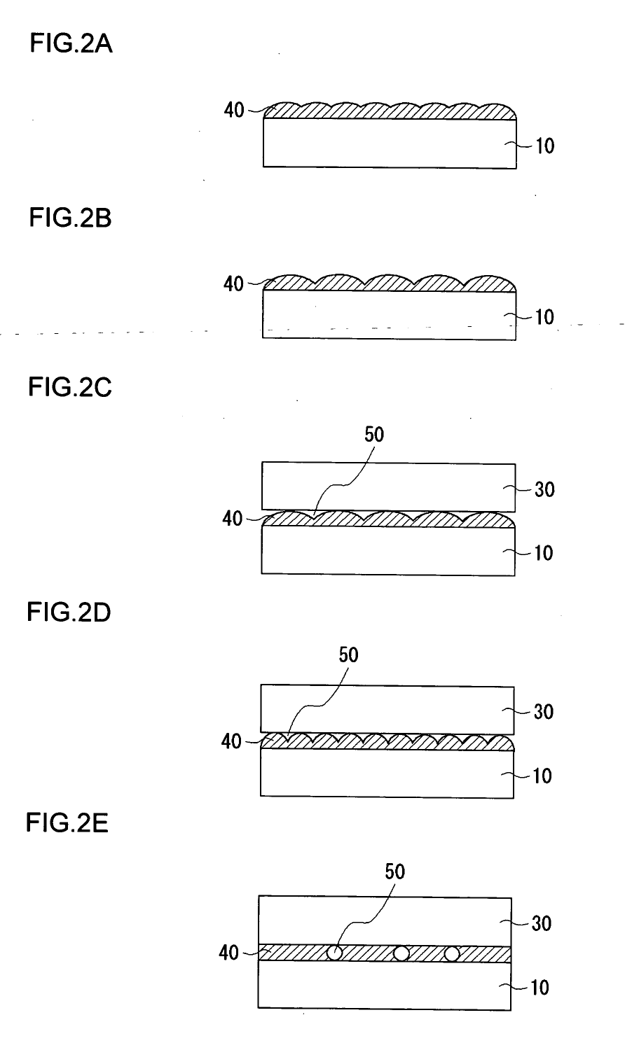

FIG. 2A, 2B, 2C, 2D and 2E show generation of microspaces 50 between substrates. As shown in FIG. 2A, when applying the adhesive 40 on the surface of the device substrate 10, small irregularity is formed in the surface of the adhesive 40. When a contact angle between the device substrate 10 and the adhesive 40 is large, the irregularity in the surface of the adhesive 40 become more prominent until the lamination step is initiated, as shown in FIG. 2B. When attaching the sealing substrate 30 under a reduced pressure as shown in FIG. 2C, microspaces derived from the irregularity in the surface of the adhesive 40 are formed between the substrates. Under a reduced pressure, volatiles in the adhesive 40 are vaporized as foams, which may lead to formation of many microspaces 50 as shown in FIG. 2D. When the adhesive 40 is viscous, these microspaces 50 remain as shown FIG. 2E even after an ambient pressure is restored. Thus, when curing the adhesive 40 by, for example, UV irradiation, the spaces may be fixed between the substrates, leading to deterioration in display properties.

In this embodiment, a technique described below is suggested for minimizing remaining microspaces between the substrates. First, for minimizing irregularity in the adhesive surface generated during application of the adhesive, the substrate surface to which the adhesive is to be applied is treated with ozone or plasma to improve wettability of the surface and allow the adhesive to evenly spread over the substrate surface. In this process, the adhesive can be applied by screen printing for applying the adhesive more evenly. Secondly, for minimizing generation of bubbles due to foaming of volatiles from the adhesive, a pressure is reduced to a first pressure P1 and then increased to a higher second pressure P2 before the lamination step. In this case, the substrate can be left under a reduced pressure for a given period before lamination to adequately remove volatiles. Thirdly, after laminating the substrates, the laminated substrates are pressurized or heated for quickly removing microspaces generated. Any of these techniques can be used to minimize microspaces remaining between the substrates. For the number of remaining microspaces in an organic EL panel according to the manufacturing process of this embodiment, spaces whose diameter is equal to or less than the longer side of a pixel in the organic EL element preferably exist in a density of 10 or less per a plane with 1 inch diagonal and those whose diameter is equal to or less than the shorter side of a pixel in the organic EL element preferably exist in a density of 50 or less per a plane with 1 inch diagonal. Thus, display properties of the organic EL panel can be improved.

The device substrate 10 may be an active or passive matrix substrate. The sealing substrate 30 may be preferably made of a material with a higher transmittance in the visible range and a higher moisture impermeability, such as a glass, a glass with a color filter and a glass with CCM (color conversion module).

The adhesive 40 may be selected from, but not limited to, thermosetting resins such as urea resins, melamine resins, phenol resins, resorcinol resins, epoxy resins, unsaturated polyester resins, polyurethane resins and acrylic resins; thermoplastic resins such as vinyl acetate resins, ethylene-vinyl acetate copolymer resins, acrylic resins, cyanoacrylates resins, polyvinyl alcohol resins, polyamide resins, polyolefin resins, thermoplastic polyurethane resins, saturated polyester resins and celluloses; radical photocurable resin adhesives comprising various acrylates selected from acrylates, urethane acrylates, epoxy acrylates, melamine acrylates and acrylic resin acrylate and a resin such as urethane polyesters; cationic photocurable resin adhesives comprising a resin such as epoxy resins and vinyl ether resins; thiol-ene addition type resin adhesives; rubber adhesives such as chloroprene rubbers, nitrile rubbers, styrene-butadiene rubbers, natural rubbers, butyl rubbers and silicone rubbers; and composite synthetic polymer adhesives such as vinyl-phenolics, chloroprene-phenolics, nitrile-phenolics, Nylon-phenolics, epoxy-phenolics and nitrile-phenolics.

In general, the adhesive 40 is preferably selected from those with a higher viscosity, e. g., no less than 0.5 Paxs. Since a viscous adhesive generally has a lower shrinking rate, a stress to a panel due to shrinkage of the adhesive during its curing can be reduced even when manufacturing a large organic EL panel. Because of its higher viscosity, the viscous adhesive can be applied by screen printing. Thus, the adhesive can be evenly applied in a shorter time, so that the adhesive can be evenly spread over the substrate surface and microspaces generated between the substrates during laminating them can be minimized. When applying a liquid crystal for a liquid crystal panel, a direct application method such as screen printing is not suitable in the light of protecting the properties of the liquid crystal device. Thus, a dropping method is generally used. However, for the organic EL panel according to this embodiment, the adhesive 40 is directly applied on the surface of the sealing substrate 30 or the device substrate 10 comprising a protective film 28. It can be, therefore, directly applied by screen printing. The adhesive 40 can be applied by non-contact screen printing.

The adhesive may comprise a filler. Examples of a filler include, but not limited to, inorganic materials such as SiOx, SiON and SiN and metal materials such as Ag, Ni and Al. The adhesive may be, for example, UV curable, visible light curable, UV- and thermosetting, thermosetting or post-curing UV curable.

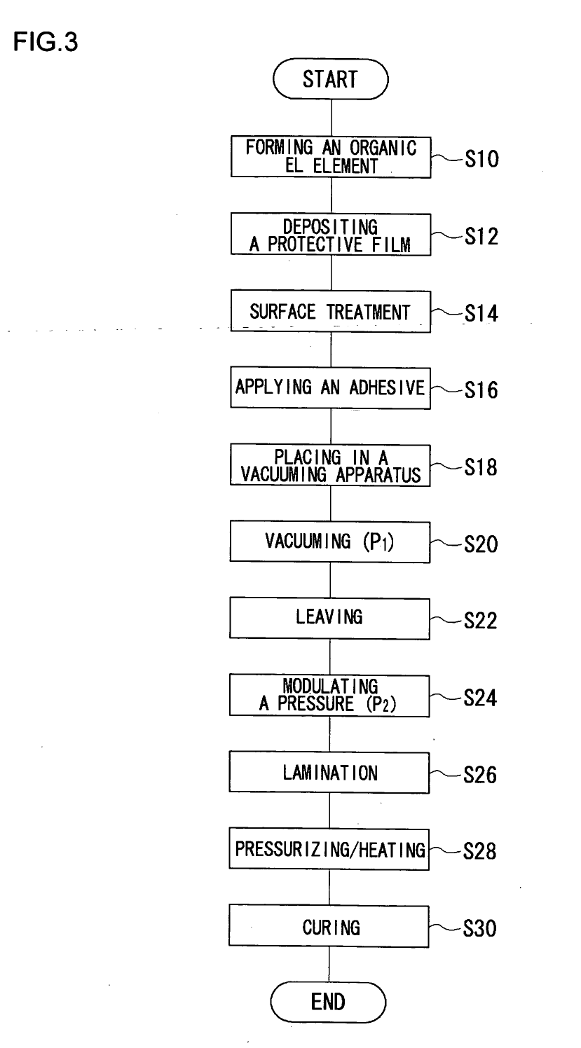

FIG. 3 is a flow chart illustrating a process for manufacturing the organic EL panel according to this embodiment. FIG. 3 shows a procedure for conducting all the technique described above, but all of these steps are not necessarily required and as described in Examples below, some of the steps can be chosen as necessary. First, an organic EL element 20 is formed on a glass substrate or a substrate 12 comprising a driving circuit such as TFT (S10). Then, on the organic EL element 20 is formed a protective film 28 (S12). One or both of the surfaces of the device substrate 10 or the sealing substrate 30 thus prepared is treated with ozone or plasma to improve wettability of the surface(s). Then, on the surface(s) is applied an adhesive 40 by screen printing (S16). After application of the adhesive 40, the product may be left for a given period to improve surface evenness.

Then, in a chamber in a vacuuming apparatus are placed the device substrate 10 and sealing substrate 30 (S18). One substrate is placed within the chamber while the other is placed on a holder. After closing the chamber, an evacuation valve is opened and the inside of the chamber is vacuumed to a first pressure P1 (1 to 10 Pa) (S20). During the process, volatiles contained in the adhesive 40 are foamed. The substrates are left for a given period until foaming ceases (S22). Then, a pressure in the chamber is increased to a second pressure P2 to prevent foaming of the volatiles (S24). After aligning the substrates, the substrate holder is moved downward to superpose the upper substrate over the lower substrate. After realignment, these substrates are laminated(S26). Then, the inside of the chamber is opened to an atmospheric pressure and further pressurized for allowing microspaces to disappear (S28). In this process, the substrate may be, if necessary, heated for reducing a viscosity of the adhesive 40. Finally, the adhesive 40 is cured using a UV lamp (S30).

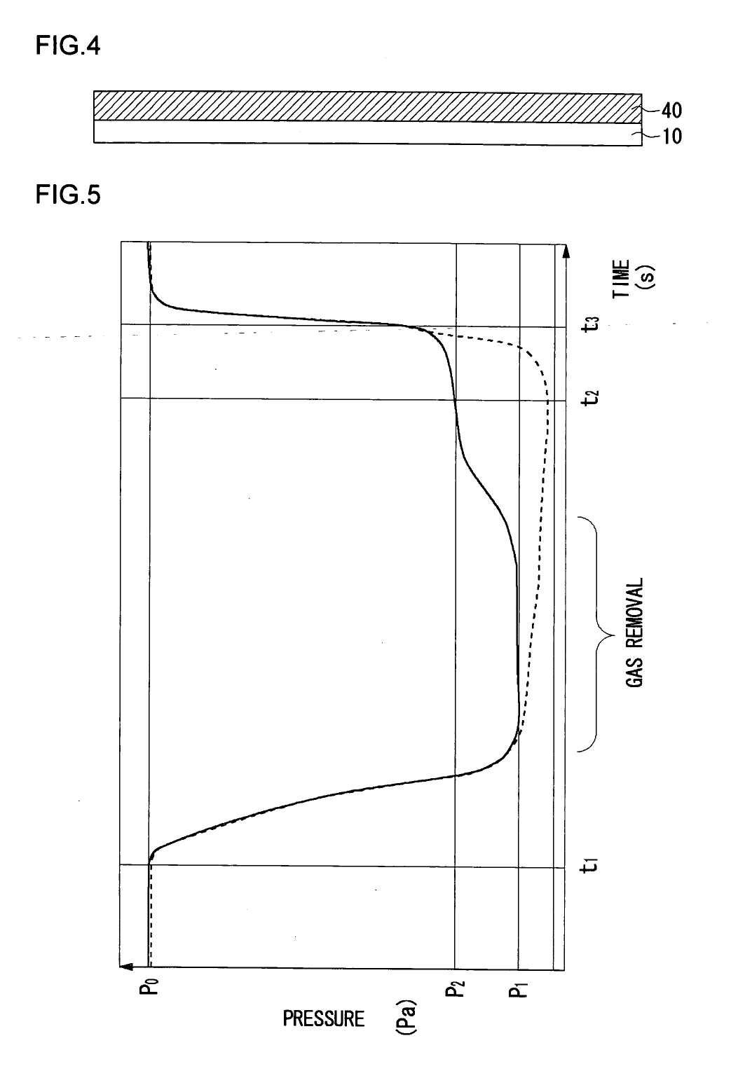

FIG. 4 schematically shows application of an adhesive after treating a substrate surface with ozone or plasma. Treating of the substrate surface with ozone or plasma using argon or nitrogen improves wettability of the surface. A contact angle is preferably 10° or less. Thus, as shown in FIG. 4, the surface of the adhesive 40 becomes so smooth that microspaces generated during lamination of the substrates can be minimized.

FIG. 5 shows variation of a pressure within a chamber in a vacuuming apparatus over time during lamination of substrates. After placing the substrates within the chamber, vacuuming is initiated at time t1 to pressure P1 which is then kept for a given period to vaporize volatiles contained in the adhesive 40. Then, a pressure is increased to P2 and the substrates are laminated. Thus, bubbles generated due to foaming of the volatiles can be minimized. Since the volatiles can be sufficiently removed to reduce residual substances such as moisture and an organic solvent in the adhesive, their adverse effect on an organic EL element 20 can be minimized to improve a working life of the element. Here, a pressure variation curve indicated by a broken line shows variation over time of a pressure within the chamber in Comparative Example 1 described later.

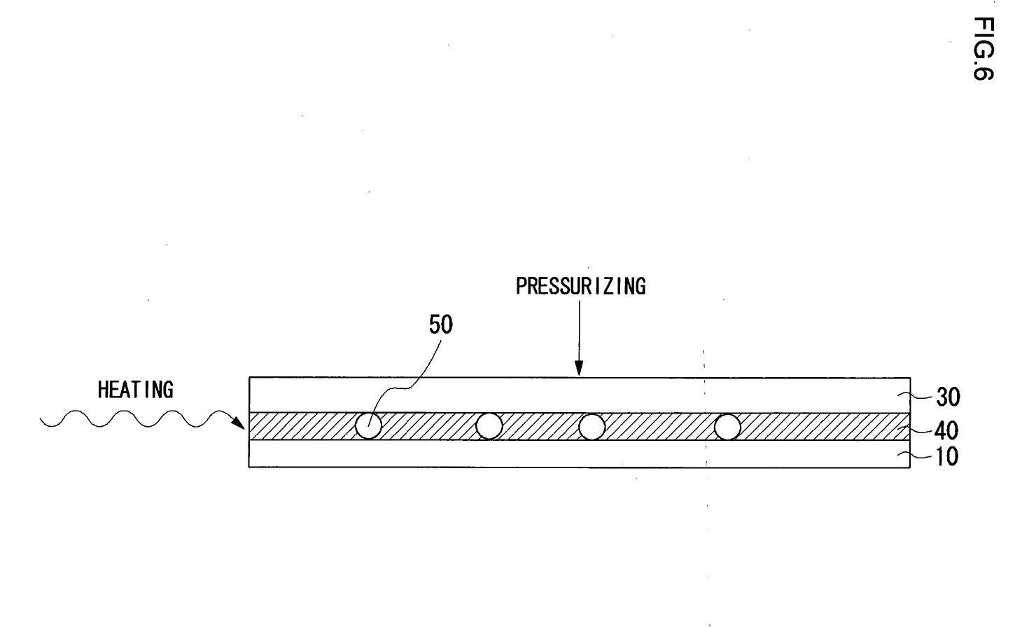

FIG. 6 schematically shows pressurizing and heating of a substrate laminate. For example, the substrate laminate is pressurized by a chamber pressure higher than an ambient pressure to compress microspaces 50 remaining between the substrates. In this process, the laminate can be heated to reduce a viscosity of the adhesive 40, so that the microspaces 50 can be more effectively and more rapidly removed. A pressure for pressurizing is preferably about 1 to 5 atoms and a heating temperature is preferably about 30 to 40°. Thus, without adverse effects on the properties of the organic EL element 20, the microspaces can be removed. Alternatively, the laminate can be heated under a reduced pressure, which is preferably higher than that during the lamination step.

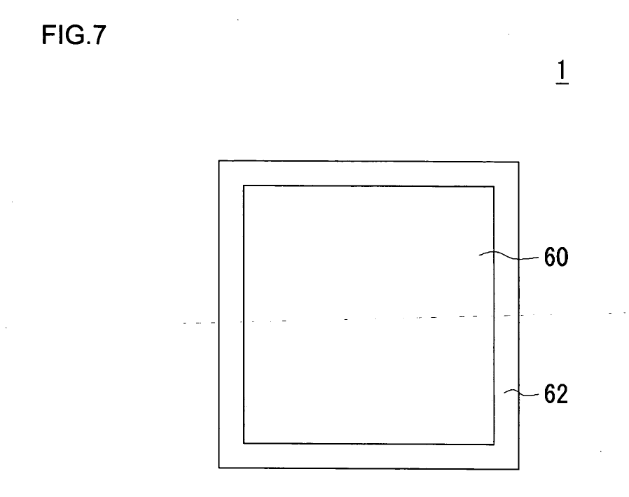

FIG. 7 illustrates an example of the use of different adhesives for a display region and a peripheral region in an organic EL panel. In an organic EL panel 1, different adhesives are applied to a first region comprising an organic EL element 20 (hereinafter, referred to as a “display region”) 60 and a peripheral second region (hereinafter, referred to as a “peripheral region”) 62. For example, for preventing moisture from permeating into the inside, an adhesive applied to the peripheral region 62 may be more moisture resistant or less water permeable than that applied to the display region 60, or an adhesive containing a filler can be used. Alternatively, for reducing a stress due to shrinkage of the adhesive, an adhesive applied to the display region 60 may be less shrinkable, or for improving display properties, more transparent than that applied to the peripheral region 62. An adhesive may be applied to the display region 60 by screen printing while an adhesive may be applied to the peripheral region 62 by a dispenser.

There will be described Examples and Comparative Example for manufacturing an organic EL panel 1 according to this embodiment and without using the technique of this embodiment, respectively. After laminating substrates, the number of microspaces remaining between the substrate were determined by optical microscopy.

### EXAMPLE 1

A protective film 28 consisting of an SiN inorganic layer was laminated on an organic EL element 20 deposited on a glass substrate 12, to prepare a device substrate 10. The device substrate 10 had a dimension of 2.2 inch (vertical)×2.2 inch (horizontal) and 220 (vertical)×176 (horizontal) pixels. Here, in a horizontal direction, three elements R, G and B are disposed per one pixel. In terms of a pixel size, a vertical longer side is 0.198 mm while a horizontal shorter side is 0.066 mm for each of R, G and B elements. The surface of the device substrate 10 was treated with plasma using argon. A contact angle was 10° or less. On the surface of the device substrate 10 was applied a UV curable epoxy resin with a viscosity of 2 Paxs by screen printing and the product was left for improving evenness. The device substrate 10 with the adhesive 40 was placed within a chamber in a vacuuming apparatus while a sealing substrate 30 without the adhesive 40 was placed on a substrate holder. The chamber was closed, a vacuum valve was opened to vacuum the chamber to 10 Pa. After aligning the substrates, the substrate holder was moved downward to superpose over the lower substrate. After realignment, the substrates were laminated. At the end of lamination, vacuum was broken in the chamber, the chamber was opened, the substrate laminate was removed and then the adhesive 40 was cured by a UV lamp. For the organic EL panel 1 manufactured in this example, the number of microspaces was determined by optical microscopy. The results was 8 spaces with a diameter of 0.2 mm (a length of the longer side of a pixel) or less per a plane with 1 inch diagonal.

### EXAMPLE 2

In this example, an organic EL panel 1 was manufactured as described in Example 1, except that both device substrate 10 and sealing substrate 30 were subjected to surface treatment. For the organic EL panel 1 manufactured in this example, the number of microspaces was 6 spaces with a diameter of 0.2 mm or less per a plane with 1 inch diagonal.

### EXAMPLE 3

In this example, the procedure described in Example 1 was repeated except that in the lamination step substrates were laminated under a controlled pressure of P2 within the chamber as indicated as a solid line in FIG. 5 without surface treatment of the substrates. For the organic EL panel 1 manufactured in this example, the number of microspaces was 5 spaces with a diameter of 0.2 mm or less per a plane with 1 inch diagonal.

### EXAMPLE 4

In this example, the procedure described in Example 1 was repeated except that without surface treatment of the substrates, a laminate was left at 30° C. and 0.2 MPa in an inert gas atmosphere for 10 min or more after lamination. For the organic EL panel 1 manufactured in this example, the number of microspaces was 4 spaces with a diameter of 0.2 mm or less per a plane with 1 inch diagonal.

### EXAMPLE 5

In this example, the procedure described in Example 1 was repeated except that both device substrate 10 and sealing substrate 30 were subjected to surface treatment and the substrates were laminated at a pressure of P2 as described in Example 3. For the organic EL panel 1 manufactured in this example, the number of microspaces was 3 spaces with a diameter of 0.2 mm or less per a plane with 1 inch diagonal.

### EXAMPLE 6

In this example, the procedure described in Example 1 was repeated except that both device substrate 10 and sealing substrate 30 were subjected to surface treatment, the substrates were laminated at a pressure of P2 as described in Example 3 and then the laminate was left at 30° C. and 0.2 MPa in an inert gas atmosphere for 10 min or more after lamination as described in Example 4. For the organic EL panel 1 manufactured in this example, the number of microspaces was one space with a diameter of 0.2 mm or less per a plane with 1 inch diagonal.

### COMPARATIVE EXAMPLE 1

In this comparative example, the procedure described in Example 1 was repeated except that without surface treatment of substrates, the substrates were laminated at a controlled pressure of P1 within the chamber as indicated with a broken line in FIG. 5 and pressurizing or heating was not conducted after lamination. For the organic EL panel 1 manufactured in this comparative example, the number of microspaces was 15 spaces with a diameter of 0.2 mm or less per a plane with 1 inch diagonal.

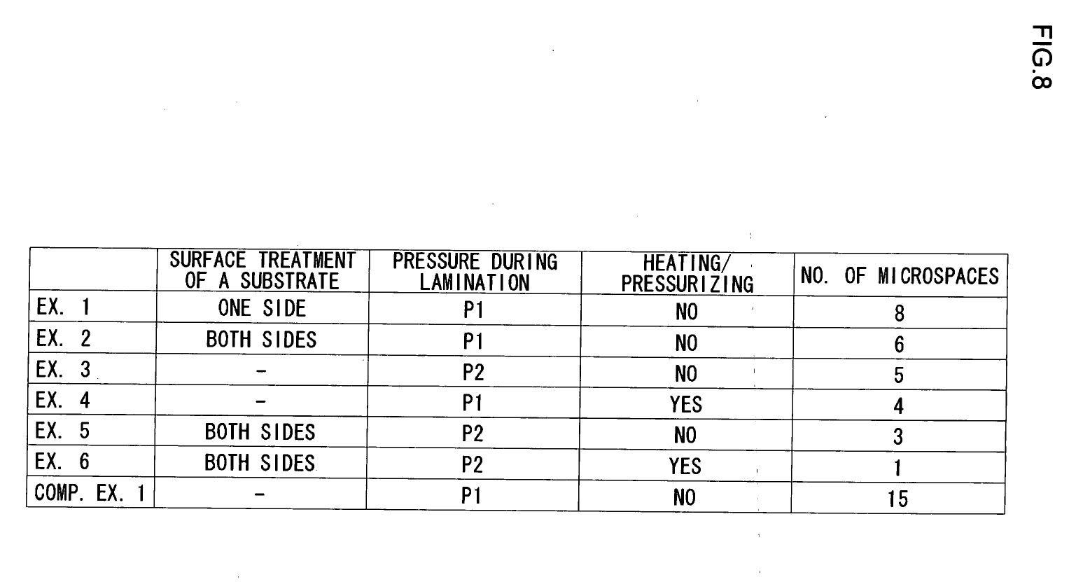

FIG. 8 shows the number of remaining microspaces in the organic EL panels 1 manufactured as described in Examples and Comparative Example. As seen from FIG. 8, the number of microspaces in the organic EL panel 1 manufactured according to any of the embodiments of this invention was smaller than that for Comparative Example, indicating that the technique of any of the embodiments can reduce the number of remaining microspaces in an organic EL panel 1. When a display size of an organic EL panel 1 is larger than a plane with 1 inch diagonal, an appropriate plane with 1 inch diagonal can be selected for determining the number of microspaces and such determination can be repeated once or more. Then, a measurement result may be a maximum, minimum or average of the measured values.

Although an organic EL panel has been described in the embodiments, the technique of the embodiments can be applied to an inorganic EL panel. When an inorganic EL panel also has a structure where a device substrate comprising an inorganic EL element and a sealing substrate are laminated for protecting the inorganic EL element as is in an organic EL panel described in the embodiments of this invention, the technique of the embodiments can be applied to securely and firmly laminate the substrates.

Although the present invention has been described by way of exemplary embodiments, it should be understood that many changes and substitutions may be made by those skilled in the art without departing from the spirit and the scope of the present invention which is defined only by the appended claims.

1. A method for manufacturing an electroluminescence panel, comprising:
applying an adhesive on a surface of at least one of a first substrate comprising an electroluminescence element and a second substrate for sealing the electroluminescence element by printing; and
laminating the first substrate and the second substrate.

2. The method for manufacturing an electroluminescence panel as claimed in claim 1, wherein said laminating is conducted under a reduced pressure.

3. The method for manufacturing an electroluminescence panel as claimed in claim 1, wherein the first substrate comprises a protective film formed on the electroluminescence element.

4. The method for manufacturing an electroluminescence panel as claimed in claim 2, wherein the first substrate comprises a protective film formed on the electroluminescence element.

5. The method for manufacturing an electroluminescence panel as claimed in claim 3, wherein the protective film is comprised of only an inorganic layer made of an inorganic material, or of a composite layer comprising the inorganic layer and an organic layer made of an organic material.

6. The method for manufacturing an electroluminescence panel as claimed in claim 4, wherein the protective film is comprised of only an inorganic layer made of an inorganic material, or of a composite layer comprising the inorganic layer and an organic layer made of an organic material.

7. The method for manufacturing an electroluminescence panel as claimed in claim 1, wherein a viscosity of the adhesive is no less than 0.5 Paxs.

8. The method for manufacturing an electroluminescence panel as claimed in claim 1, further comprising treating the surface of the first or the second substrate by ozone or plasma before said applying.

9. The method for manufacturing an electroluminescence panel as claimed in claim 1, wherein said laminating comprises:
placing the first and the second substrates in a vacuum apparatus;
vacuuming the vacuum apparatus to a first pressure;
increasing the pressure in the vacuum apparatus to a second pressure higher than the first pressure; and
laminating the first and the second substrates under the second pressure.

10. The method for manufacturing an electroluminescence panel as claimed in claim 9, further comprising leaving the product for a given period for removing volatiles in the adhesive before said vacuuming and after said increasing the pressure.

11. The method for manufacturing an electroluminescence panel as claimed in claim 1, further comprising, after said laminating, heating the laminated substrates under an inert gas atmosphere or under a reduced pressure, or pressurizing the laminate under an inner pressure of the vacuuming apparatus higher than an ambient pressure.

12. The method for manufacturing an electroluminescence panel as claimed in claim 1, wherein in said applying, different adhesives are used for a first region comprising the electroluminescence element in the electroluminescence panel and a second region around the first region.

13. The method for manufacturing an electroluminescence panel as claimed in claim 12, wherein an adhesive applied on the second region is more moisture resistant or less water permeable than an adhesive applied on the first region.

14. The method for manufacturing an electroluminescence panel as claimed in claim 12, wherein the adhesive applied on the first region may be less shrinkable or more transparent than the adhesive applied on the second region.

15. An electroluminescence panel which is manufactured by the method as claimed in claim 1.

16. An electroluminescence panel comprising:
a first substrate comprising an electroluminescence element;
a second substrate for sealing the electroluminescence element; and
an adhesive layer applied on a surface of at least one of the first substrate and the second substrate by printing for laminating the first substrate and the second substrate.

17. An electroluminescence panel comprising a first substrate comprising an electroluminescence element and a second substrate for sealing the electroluminescence element,
wherein there exist microspaces generated under a reduced pressure which remain between the first and the second substrates and whose diameter is equal to or less than the longer side of a pixel in the electroluminescence element, in a density of 10 or less per a plane with 1 inch diagonal.

18. An electroluminescence panel comprising a first substrate comprising an electroluminescence element and a second substrate for sealing the electroluminescence element,
wherein there exist microspaces generated under a reduced pressure which remain between the first and the second substrates and whose diameter is equal to or less than the shorter side of a pixel in the electroluminescence element, in a density of 50 or less per a plane with 1 inch diagonal.
